(19) United States
(12) Patent Application Publication
(10) Pub. No.: US 2007/0138804 A1
(43) Pub. Date: Jun. 21, 2007

(54) Support assembly for a refrigerator storage pan

(75) Inventors: Phillip Koloff, Louisville, KY (US); Joseph M. Miller, Louisville, KY (US); Ravikiran Gopalakrishna, Andrapradesh (IN)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/297,252

(22) Filed: Dec. 8, 2005

(51) Int. Cl. E05C 3/04

(52) U.S. Cl. 292/204

(57) ABSTRACT

A drawer assembly for a refrigerator having compartment walls defining a cooling compartment is provided. The drawer assembly includes a pan having a mounting portion, and a bracket coupled to one of the compartment walls. The bracket includes a locking mechanism movable between a first position and a second position. The pan is mounted to the bracket such that the locking mechanism engages the mounting portion of the pan. Wherein the pan is secured to the bracket when the locking mechanism is in the first position, and the pan is configured to be removed from the bracket when the locking mechanism is in the second position.

### BACKGROUND OF THE INVENTION

This invention relates generally to refrigerator storage chambers, and more particularly, to a support assembly for a refrigerator storage pan.

A typical household refrigerator includes a freezer storage compartment and a fresh food storage compartment either arranged side-by-side and separated by a center mullion wall, or arranged over-and-under and separated by a horizontal center mullion wall. Storage shelves and storage drawers or pans typically are provided in the fresh food compartment, and storage shelves and wire baskets typically are provided in the freezer compartment. In some refrigerators, the storage pans may be maintained at a temperature that is different from the temperature of the compartment in which the storage pan is located. In addition, an ice maker may be provided in the freezer compartment. A freezer door and a fresh food door close the access openings to the freezer and fresh food compartments, respectively.

Storage pans are typically provided in a lower portion of the refrigerator for storing fresh fruits and vegetables or in some cases, fresh meats. The storage pans are generally suspended from a support structure that includes a track or glide that facilitates sliding movement of the storage pan in and out of the compartment.

While slide-out storage drawers and pans are desirable for convenient access, they can be difficult to use. In at least some known refrigerators, the storage pan can unexpectedly come all of the way out of its track, spilling the contents of the pan when a user tries to fully open the pan. Alternatively, in other refrigerators, the travel of the storage pan is limited so that it doesn't easily come all of the way out, which limits access to the contents of the pan. Such pans may also be difficult to remove for cleaning.

### BRIEF DESCRIPTION OF THE INVENTION

In one aspect, a drawer assembly for a refrigerator having compartment walls defining a cooling compartment is provided. The drawer assembly includes a pan having a mounting portion, and a bracket coupled to one of the compartment walls. The bracket includes a locking mechanism movable between a first position and a second position. The pan is mounted to the bracket such that the locking mechanism engages the mounting portion of the pan. The pan is secured to the bracket when the locking mechanism is in the first position, and the pan is configured to be removed from the bracket when the locking mechanism is in the second position.

In another aspect, a refrigerator is provided. The refrigerator includes a cooling compartment defined by a plurality of compartment walls, and a pan assembly slidably mounted within the cooling compartment. The pan assembly includes a pan having a mounting portion and a bracket coupled to one of the compartment walls, and the bracket includes a locking mechanism movable between a first position and a second position. The pan is mounted to the bracket such that the locking mechanism engages the mounting portion of the pan, wherein the pan is secured to the bracket when the locking mechanism is in the first position, and the pan is configured to be removed from the bracket when the locking mechanism is in the second position.

In still another aspect, a method for assembling a drawer assembly for a refrigerator having a cooling compartment defined by a plurality of compartment walls is provided. The method includes coupling a bracket to one of the compartment walls of the refrigerator and, coupling a locking mechanism to the bracket, wherein the locking mechanism is movable between a first position and a second position. The method further includes mounting a pan having a mounting portion to the bracket such that the locking mechanism engages the mounting portion. The pan is secured to the bracket when the locking mechanism is in the first position, and the pan is configured to be removed from the bracket when the locking mechanism is in the second position.

### BRIEF DESCRIPTION OF THE DRAWINGS

FIG. 1 is a perspective view of a refrigerator.

FIG. 2 is a partial perspective cut away view of a portion of FIG. 1.

FIG. 3 is a perspective exploded view illustrating a bottom pan and a support assembly.

FIG. 4 is a perspective view of a slidable bracket.

FIG. 5 is a perspective view of the bottom pan mounted on the bracket shown in FIG. 4.

FIG. 6 illustrates a swing lock positioned in a first position.

FIG. 7 illustrates the swing lock positioned in a second position.

FIG. 8 is a perspective view of a bracket in an alternative embodiment.

FIG. 9 is a perspective view of a bracket in an alternative embodiment.

FIG. 10 is a perspective view of a retainer applicable to the bracket shown in FIG. 9.

FIG. 11 is a perspective view of a bracket in still an alternative embodiment.

FIG. 12 is a perspective view of an alternative snap lock applicable the bracket shown in FIG. 11.

FIG. 13 is a perspective view of an alternative snap lock applicable the bracket shown in FIG. 11.

FIG. 14 is a perspective view of still an alternative bracket having a locking mechanism.

FIG. 15 is a perspective view of the locking mechanism shown in FIG. 14 positioned in a first position.

FIG. 16 is a perspective view of the locking mechanism shown in FIG. 14 positioned in a second position.

FIG. 17 is a perspective view of still an alternative bracket having a locking mechanism.

FIG. 18 is a perspective view of the locking mechanism shown in FIG. 17 slidable between a first and second position.

FIG. 19 is a perspective view of a bracket in still an alternative embodiment.

FIG. 20 is a perspective view of a bracket in still an alternative embodiment.

### DETAILED DESCRIPTION OF THE INVENTION

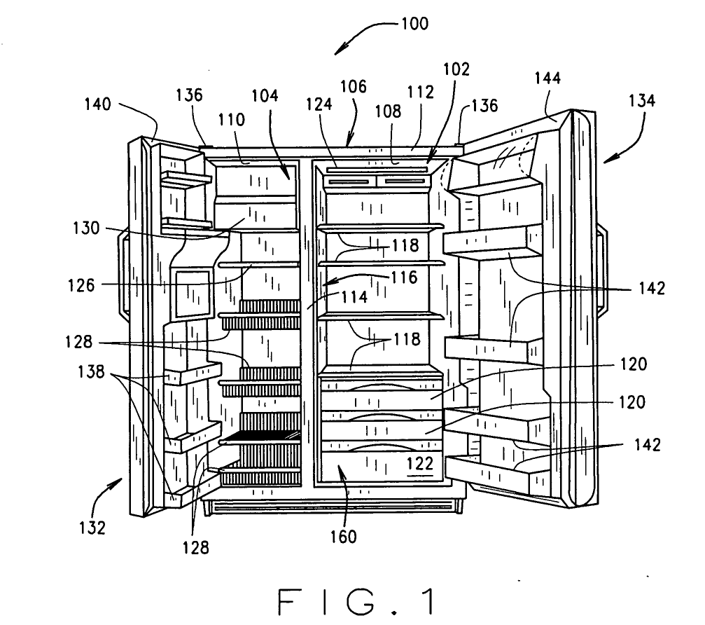

FIG. 1 illustrates a side-by-side refrigerator 100 including a fresh food storage compartment 102 and a freezer storage compartment 104 are arranged side-by-side. A side-by-side refrigerator similar to refrigerator 100 is commercially available from General Electric Company, Appliance Park, Louisville, Ky. 40225.

Refrigerator 100 includes an outer case 106 and inner liners 108, 110. A space between case 106 and liners 108 and 110, and between liners 108 and 110, is filled with foamed-in-place insulation. Outer case 106 normally is formed by folding a sheet of a suitable material, such as pre-painted steel, into an inverted U-shape to form top and side walls of case 106. A bottom wall of case 106 normally is formed separately and attached to the case side walls and to a bottom frame that provides support for refrigerator 100. Inner liners 108 and 110 are molded from a suitable plastic material to form freezer compartment 104 and fresh food compartment 106, respectively. Alternatively, liners 108, 110 may be formed by bending and welding a sheet of a suitable metal, such as steel. The illustrative embodiment includes two separate liners 108, 110 as it is a relatively large capacity unit and separate liners add strength and are easier to maintain within manufacturing tolerances. In smaller refrigerators, a single liner is formed and a mullion spans between opposite sides of the liner to divide it into a freezer compartment and a fresh food compartment.

A breaker strip 112 extends between a case front flange and outer front edges of liners. Breaker strip 112 is formed from a suitable resilient material, such as an extruded acrylo-butadiene-styrene based material (commonly referred to as ABS).

The insulation in the space between liners 108, 110 is covered by another strip of suitable resilient material, which also commonly is referred to as a mullion 114. Mullion 114 also preferably is formed from an extruded ABS material. It will be understood that in a refrigerator with separate mullion dividing a unitary liner into a freezer and a fresh food compartment, a front face member of mullion corresponds to mullion 114. Breaker strip 112 and mullion 114 form a front face, and extend completely around inner peripheral edges of case 106 and vertically between liners 108, 110. Mullion 114, insulation between compartments, and a spaced wall of liners separating compartments, sometimes are collectively referred to herein as a center mullion wall 116.

Shelves 118 and slide-out drawers 120 normally are provided in fresh food compartment 102 to support items being stored therein. Refrigerator 100 also includes a bottom pan 122 that may be a part of a quick chill and thaw system (not shown in FIG. 1) that is selectively controlled, together with other refrigerator features, by a microprocessor (not shown in FIG. 1) according to user preference via manipulation of a control interface 124 mounted in an upper region of fresh food storage compartment 102 and coupled to the microprocessor. Shelves 126 and wire baskets 128 are also provided in freezer compartment 104. In addition, an ice maker 130 may be provided in freezer compartment 104.

A freezer door 132 and a fresh food door 134 close access openings to fresh food and freezer compartments 102, 104, respectively. Each door 132, 134 is mounted by a top hinge 136 and a bottom hinge (not shown) to rotate about its outer vertical edge between an open position, as shown in FIG. 1, and a closed position (not shown) closing the associated storage compartment. Freezer door 132 includes a plurality of storage shelves 138 and a sealing gasket 140, and fresh food door 134 also includes a plurality of storage shelves 142 and a sealing gasket 144.

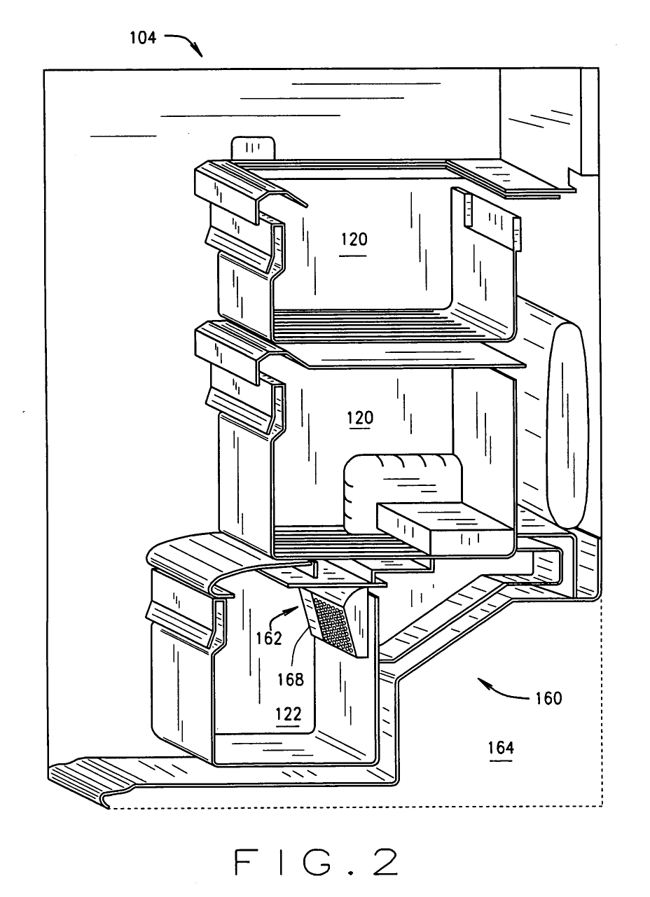

FIG. 2 is a partial cutaway view of fresh food compartment 102 illustrating storage drawers 120 stacked upon one another and positioned above a quick chill and thaw system 160. Quick chill and thaw system 160 includes an air handler 162 and pan 122 located adjacent to a machinery compartment 164 (shown in phantom in FIG. 2) to minimize fresh food compartment space utilized by quick chill and thaw system 160. A leading edge 168 of air handler 162 projects into pan 122. Storage drawers 120 are conventional slide-out drawers without internal temperature control. A temperature of storage drawers 120 is therefore substantially equal to an operating temperature of fresh food compartment 102. Bottom pan 122 is positioned slightly forward of storage drawers 120 to accommodate machinery compartment 164, and air handler 162 selectively controls the air temperature of pan 122 and circulates air within pan 122 to increase heat transfer to and from pan contents for timely thawing and rapid chilling, respectively, as described in detail below. When quick thaw and chill system 160 is inactivated, pan 122 reaches a steady state at a temperature equal to the temperature of fresh food compartment 102, and pan 122 functions as a third storage drawer. In alternative embodiments, greater or fewer numbers of storage drawers 120 and quick chill and thaw systems 160, and other relative sizes of quick chill pans 122 and storage drawers 120, are employed.

In accordance with known refrigerators, machinery compartment 164 at least partially contains components for executing a vapor compression cycle for cooling air. The components include a compressor (not shown), a condenser (not shown), an expansion device (not shown), and an evaporator (not shown) connected in series and charged with a refrigerant. The evaporator is a type of heat exchanger which transfers heat from air passing over the evaporator to a refrigerant flowing through the evaporator, thereby causing the refrigerant to vaporize. The cooled air is used to refrigerate one or more refrigerator or freezer compartments.

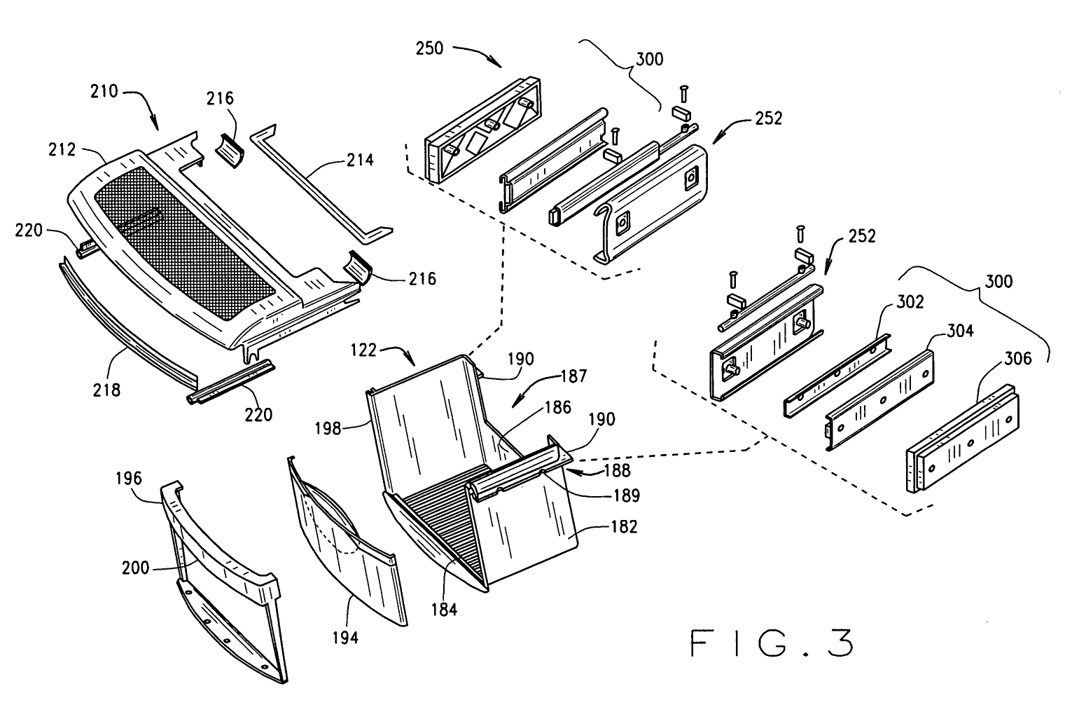

FIG. 3 is a perspective exploded view illustrating a bottom pan 122. Pan 122 includes opposite side walls 182, a bottom wall 184 extending between side walls 182, and a rear wall 186 including a cutout portion 187 for receiving air handler leading edge 168. Pan side walls 182 each includes an outwardly projecting mounting portion 188, and each mounting portion 188 further includes a plurality of openings 189 defined therethrough. Rear wall 186 includes rearward facing engagement tabs 190. A window 194 fabricated from a transparent material is received in a cover 196 that is attached to a front 198 of pan 122. Cover 196 includes an outwardly curved handle 200 for user manipulation to open and close pan 122.

When pan 122 is in a closed position, pan 122 is covered by a stationary cover assembly 210. Cover assembly 210 is attached to the interior of fresh food compartment 102. Cover assembly 210 includes cover top 212 and a seal frame member 214. Rear gaskets 216, a front gasket 218, and side cover gaskets 220 are provided to facilitate sealing pan 122, particularly during operation of quick chill and thaw system 160.

Bottom pan 122 is supported by a support assembly 250 that facilitates extension and retraction of pan 122 from fresh food compartment 102. Support assembly 250 includes right and left brackets 252, which in an exemplary embodiment are substantially identical. Brackets 252 may engage with side walls 182 of pan 122, respectively, to support pan 122 thereon. Brackets 252 are fabricated from a rigid material, such as, for example, a plastic material or a metal material.

A slide assembly 300 is coupled to each bracket 252. Slide assemblies 300 facilitate sliding movement of pan 122 out of and into fresh food compartment 102. Each slide assembly 300 is of well known construction and includes a slide pan 302, a slide liner 304 and a slide spacer 306. Slide pan 302 is coupled to bracket 252 while slide liner 304 and slide spacer 306 are attached to an interior wall of fresh food compartment 102. As such, bracket 252 is slidably coupled to fresh food compartment 102, and further, pan 122 is slidably coupled to fresh food compartment 102 when engaging brackets 252. Specifically, slide assembly 300 is a full extension slide assembly that allows easy access to the contents of pan 122.

FIG. 4 illustrates bracket 252 in detail. Bracket 252 includes a generally C-shaped channel 320 that includes a side wall 322, an upper wall 324, and a bottom wall 326 connecting with side wall 322. Bracket 252 also includes a retainer 328 mounted thereon for engaging pan 122.

In the exemplary embodiment, retainer 328 includes an elongated retainer bar 330 for mounting on upper wall 324 of bracket 252, and two locking mechanisms, more specifically, swing locks 332 mounted on retainer bar 330. Each swing lock 332 includes a retaining member 334 extending upward from retainer bar 330, and a tab 336 rotatably mounted on retaining member 334. In one embodiment, each tab 336 further includes a handle 338 extending outwardly from a free end thereof, and handle 338 may be held by an operator to rotate tab 336. In an alternative embodiment, retainer bar 330 is unitarily formed with bracket 252.

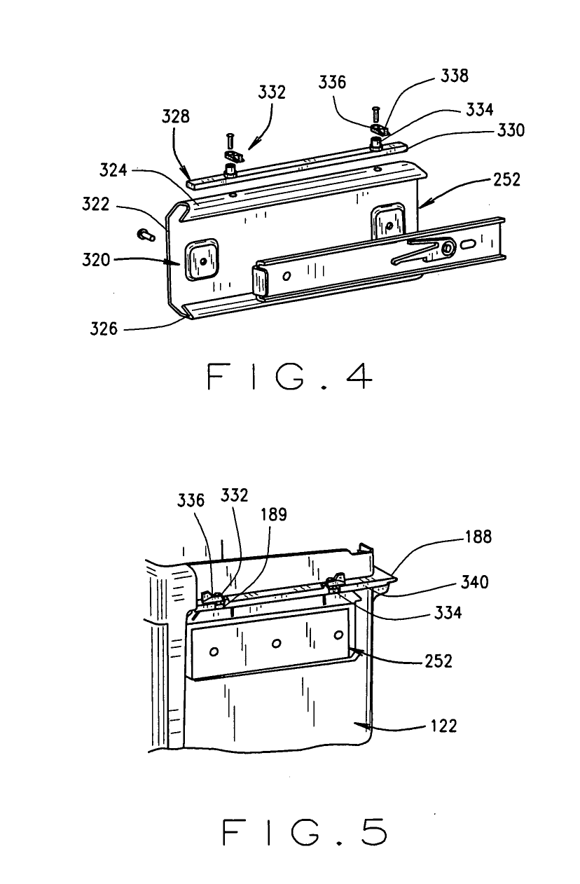

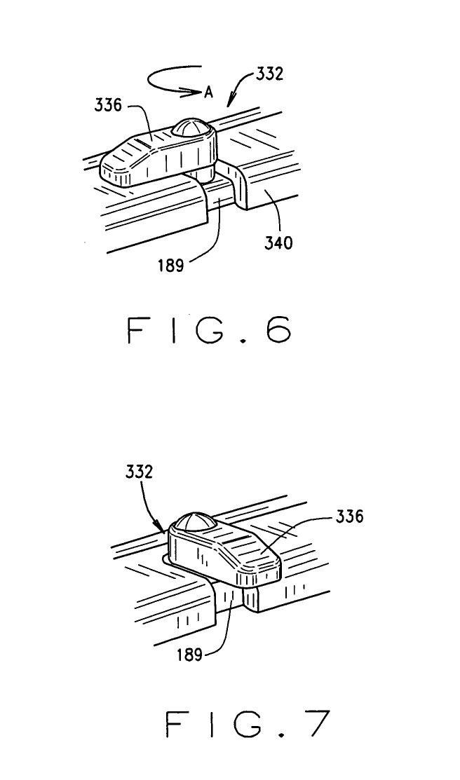

FIG. 5 is a perspective view of pan 122 mounted on bracket 252 shown in FIG. 3, and FIGS. 6 and 7 illustrate swing lock 332 positioned in a first position and a second position, respectively. In the exemplary embodiment, openings 189 are modified as two cut outs complementary in shape with swing lock 332 for allowing swing lock 332 to insert therethrough. When mounting pan 122 onto bracket 252, mounting portion 188 is put onto the top of bracket 252, retaining member 334 is inserted through and received in the corresponding opening 189, and tab 336 is exposed above mounting portion 188. In one embodiment, mounting portion 188 further includes a rim 340 extending downward therefrom, and rim 340 prevents swing lock 332 from moving laterally to disengage with mounting portion 188.

When swing lock 332 is positioned in the first position (shown in FIG. 6), tab 336 is positioned misaligned with opening 189, and mounting portion 188 is sandwiched between tab 336 and retainer bar 330, such that pan 122 is secured on bracket 252. When swing lock 332 is rotated to the second position (shown in FIG. 7) along the direction indicated as arrow A, tab 336 is positioned substantially aligned with opening 189, such that pan 122 may be lifted upward to disengage with swing lock 332. As such, swing lock 332 may be rotated to the first position to secure pan 122 on bracket 252, and may also be manually rotated to the second position to facilitate pan 122 mounting onto or being removed from bracket 252.

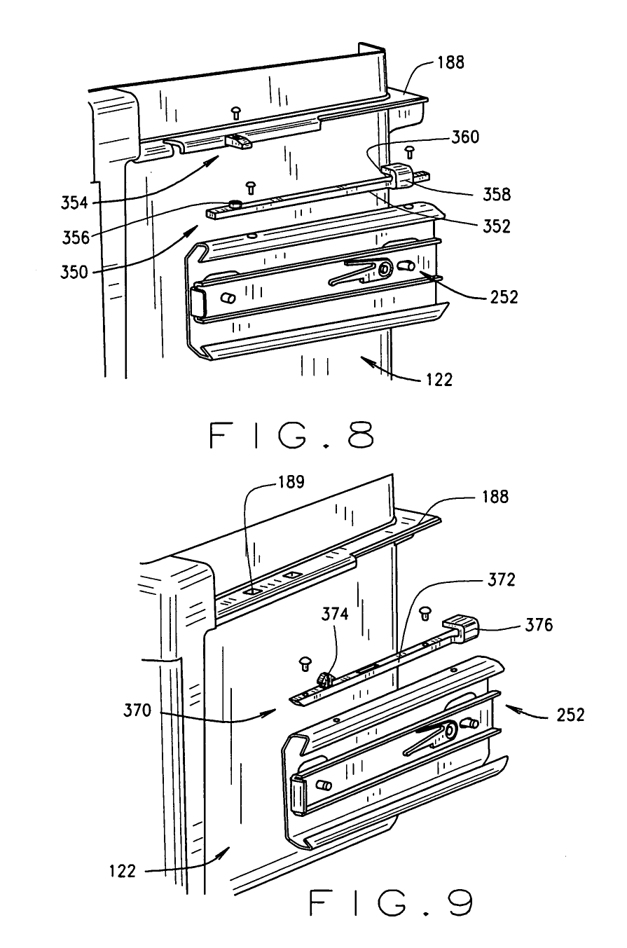

FIG. 8 illustrates an alternative embodiment of bracket 252 including a retainer 350 in lieu of retainer 328 (shown in FIG. 4). Retainer 350 includes an elongated retainer bar 352 for mounting on bracket 252, and a swing lock 354 having a retaining member 356. Swing lock 354 is similar to swing lock 332 (shown in FIG. 4) in structure. Swing lock 354 is movable between a first position and a second position. Retainer 350 further includes a hook member 358 extending from retainer bar 352, and hook member 358 defines a receiving slot 360 for receiving a portion of mounting portion 188. Opening 189 is modified as a cut out complementary in shape with swing lock 332 for allowing swing lock 332 to be inserted therethrough. To mount pan 122 onto bracket 252, hook member 358 engages, and receives a portion of, mounting portion 188, retaining member 356 is inserted through opening 189, and swing lock 354 is then rotated to the first position to secure pan 122 thereon.

FIGS. 9 and 10 illustrate an alternative embodiment of bracket 252 which includes a retainer 370 in lieu of retainer 328 (shown in FIG. 4). Retainer 370 includes an elongated retainer bar 372 for mounting on upper wall 324 of bracket 252, a locking mechanism, more specifically, snap lock 374 formed on retainer bar 372, and a hook member 376 formed at an end of retainer bar 372 and structurally similar with hook member 358 (shown in FIG. 8). Snap lock 374 includes two bifurcated retaining members 378 extending upward from retainer bar 372 and arranged at a back-to-back relation. Each retaining member 378 includes an engaging protrusion 380 extending outward therefrom, and each engaging protrusion 380 has a slant surface 382 and a horizontal surface 384 connecting with slant surface 382.

Opening 189 is formed as a substantially rectangular aperture defined through mounting portion 188 to accommodate snap lock 374. When mounting pan 122 onto bracket 252, retaining members 378 are inserted into opening 189 and slant surface 382 facilitates the corresponding retaining member 378 bending inward to allow the insertion. After the insertion, snap lock 374 resiliently returns to the first position. A portion of retaining member 378 is then received in opening 189, and horizontal surface 384 of retaining member 378 engages mounting portion 188, such that pan 122 is retained by snap lock 374. In one embodiment, snap lock 374 is compressed by an operator such that retaining members 378 are resiliently deformed inward to the second position. Retaining members 378 disengage with opening 189 which facilitates removing snap lock 374 from opening 189. As such, snap lock 374 is positioned in the first position to lock pan 122 thereon, and may also be positioned in the second position to allow pan 122 to be removed therefrom.

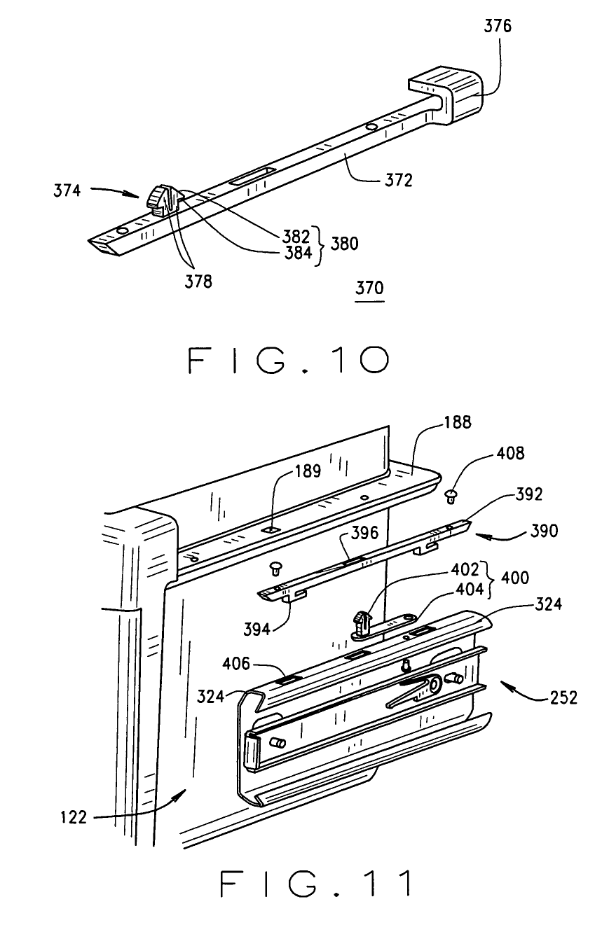

FIG. 11 illustrates an alternative embodiment of bracket 252 which includes a retainer 390 in lieu of retainer 370 (shown in FIG. 9). Retainer 390 includes an elongated retainer bar 392, two clasp members 394 extending downward from retainer bar 392 for engaging bracket 252, and a mounting slot 396 defined through retainer bar 392.

Retainer 390 also includes a separately provided locking mechanism, more specifically, snap lock 400 for engaging opening 189 of pan 122. Snap lock 400 further includes two bifurcated retaining members 402 which are substantially identical with retaining members 378 (shown in FIG. 10), except that retaining member 402 extends upward from a flat base member 404 instead of directly from retainer bar 392.

Bracket 252 further defines two rectangular slots 406 at upper wall 324 thereof. Slots 406 are substantially complementary in shape with and located corresponding to clasp members 394. As such, when assembling retainer 390 onto bracket 252, clasp members 394 are inserted through corresponding slots 406, and clasp members 394 then slide longitudinally to secure retainer bar 392 onto bracket 252. Base member 404 of snap lock 400 is sandwiched between retainer bar 392 and bracket 252, and retaining members 402 are inserted through and exposed above mounting slot 396 of retainer bar 392. In an exemplary embodiment, a plurality of fasteners 408 may be further employed to secure retainer bar 392 onto bracket 252, respectively.

Opening 189 is modified as a substantially rectangular aperture defined through mounting portion 188 to engage snap lock 400 when mounting pan 122 onto bracket 252. Similar to snap lock 374 (shown in FIG. 10), snap lock 400 is also movable between an original position, i.e., the first position, which locks pan 122 thereon, and an inward deformed position, i.e., the second position, which allows pan 122 to be removed therefrom.

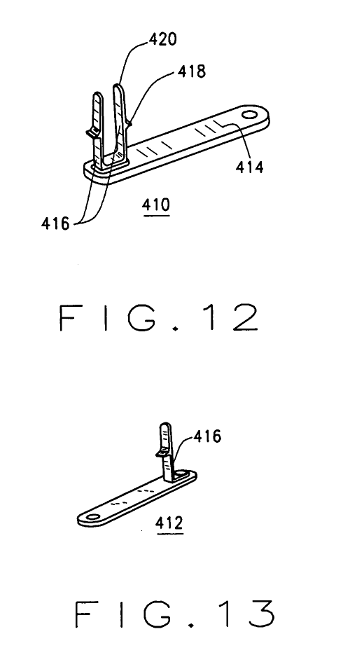

FIGS. 12 and 13 illustrate snap locks 410, 412 applicable to retainer 390 shown in FIG. 11. Snap lock 410 includes a flat base member 414, and two retaining members 416 extending upward from base member 414. Retaining member 416 is similar to retaining members 378, 402 (shown in FIGS. 10, 11) in shape. Each retaining member 416 further includes an engaging protrusion 418 extending outward therefrom, and a handle 420 extending upward and beyond engaging protrusion 418. Snap lock 412 is substantially identical with snap lock 410 in shape, except that snap lock 412 only includes one retaining member 416 extending upward therefrom.

It is appreciated that snap locks 410, 412 may be assembled into retainer 390 and movable between a first position and a second position in a similar way as snap lock 400 (shown in FIG. 11). Handle 420 facilitates manipulating snap lock 410 to resiliently deform from the first position to the second position. Snap locks 400, 410, and 412 are separately provided from retainer bar 392 (shown in FIG. 11), which facilitates changing a broken snap lock without changing the entire retainer.

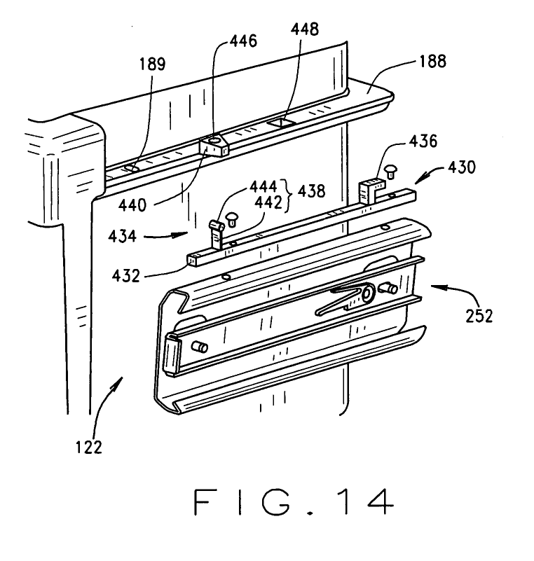

FIG. 14 illustrates another embodiment of bracket 252 which includes a retainer 430 in lieu of retainer 328 (shown in FIG. 4). Retainer 430 includes an elongated retainer bar 432 for mounting on bracket 252, and a locking mechanism 434 mounted on retainer bar 432. Retainer 430 also includes a hook member 436 extending upward from retainer bar 432.

Locking mechanism 434 includes a retaining member 438 extending upward from retainer bar 432, and a retainer clip 440 for rotatably engaging retaining member 438. Retaining member 438 further includes a cylindrical rod 442 formed on retainer bar 432 and an elongated head 444 extending substantially perpendicularly with respect to rod 442. Retainer clip 440 further includes a retaining slot 446 defined therethrough and substantially complementary in shape with elongated head 444.

Retainer 430 is mounted onto bracket 252 by screws (not shown). Opening 189 of mounting portion 188 is modified as an elongated aperture substantially complementary in shape with elongated head 444 for receiving retaining member 438 therein. Mounting portion 188 further defines a rectangular hole 448. To mount pan 122 onto bracket 252, rod 442 of retaining member 438 is received in opening 189, and elongated head 444 extends above mounting portion 188. Elongated head 444 is inserted through retaining slot 446 and secured by retainer clip 440.

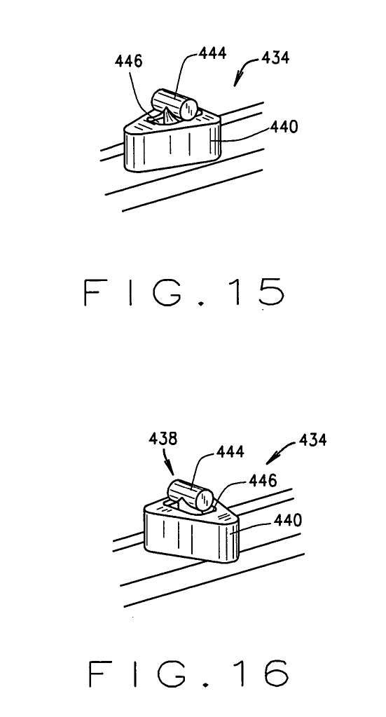

FIGS. 15 and 16 illustrate locking mechanism 434 in a first position and a second position, respectively. When locking mechanism 434 is positioned in the first position (shown in FIG. 15), retaining slot 446 is misaligned with elongated head 444, such that pan 122 is secured on bracket 252. When retainer clip 440 is rotated to the second position (shown in FIG. 16), retaining slot 446 is substantially aligned with elongated head 444, such that retainer clip 440 may be removed from retaining member 438, and pan 122 may be then lifted upward to disengage retaining member 438.

FIG. 17 illustrates embodiment of bracket 252 which includes a retainer 450 in lieu of retainer 328 (shown in FIG. 4). Retainer 450 includes an elongated retainer bar 452 for mounting on bracket 252, and two locking mechanisms 454 mounted on retainer bar 452. Each locking mechanism 454 includes a retaining member 456 extending upward from retainer bar 452, and a retainer clip 458 for engaging retaining member 456. Each retaining member 456 further includes a cylindrical rod 460 formed on retainer bar 432, and an enlarged rounded head 462 formed at a top end of rod 460. Retainer clip 458 further includes a retaining slot 464 defined therethrough for receiving retaining member 456. Retaining slot 464 includes a first portion 466 sized to receive rod 460 and smaller than head 462. Retaining slot 464 also includes a second portion 468 substantially complementary with rounded head 462, and a middle portion 470 sized to inhibit movement of rod 460 there through. Middle portion 470 is sized smaller than first portion 466, such that retaining member 456 is retained in first portion 466 until a sufficient force is supplied to rod 460.

Retainer 450 is mounted onto upper wall 324 of bracket 252 by screws. Openings 189 of mounting portion 188 are formed as two circular apertures. To mount pan 122 onto bracket 252, retaining member 456 is inserted through the corresponding opening 189, and rounded head 462 extends above mounting portion 188. Rounded head 462 is inserted through retaining slot 464 of retainer clip 458 via second portion 468, and is secured within retainer clip 458.

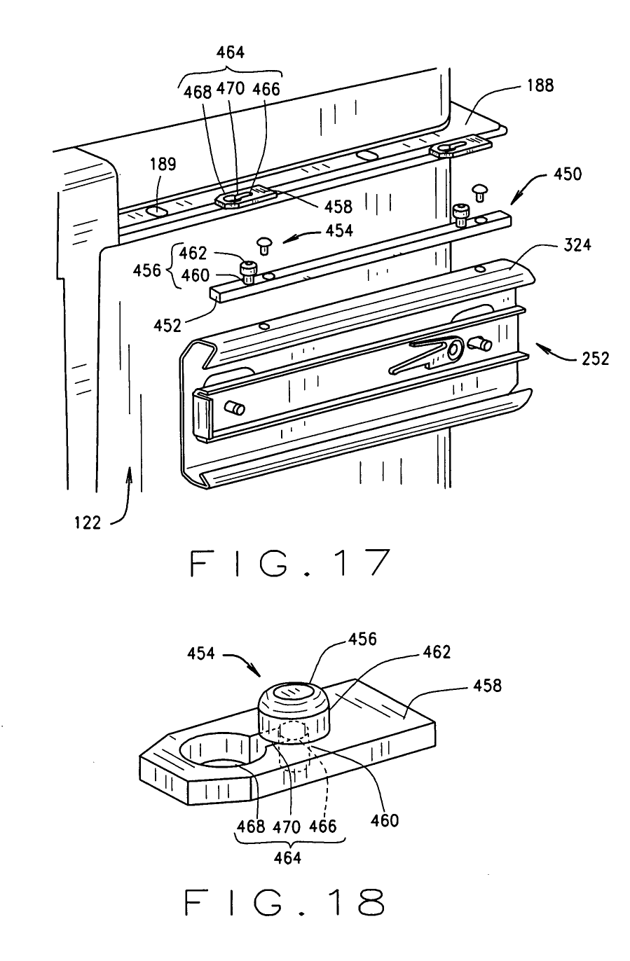

FIG. 18 illustrates locking mechanism 454 slidable between a first position and a second position. When locking mechanism 454 is positioned in the first position (shown in FIG. 18), rod 460 is received in first portion 466 of retaining slot 464, such that pan 122 is secured on bracket 252. When retainer clip 440 is moved by the operator to the second position, rod 460 is received in second portion 468 of retaining slot 464, such that retainer clip 458 is removed from retaining member 456, and pan 122 may then be lifted upward to disengage retaining member 456.

FIG. 19 illustrates an embodiment of bracket 252 which includes a retainer 480 in lieu of retainer 328 (shown in FIG. 4). Retainer 480 includes an elongated retainer bar 482, and two locking mechanisms 484 mounted on retainer bar 482. Each locking mechanism 484 includes a threaded retaining member 486 extending upward from retainer bar 482, and a threaded nut 488 configured to engage retaining member 486. In one exemplary embodiment, each threaded nut 488 further includes a serrated outer surface 490 which facilitates rotating threaded nut 488.

Retainer 450 is mounted onto upper wall 324 of bracket 252 by screws, and opening 189 is modified as two circular apertures defined through mounting portion 188. To mount pan 122 onto bracket 252, openings 189 receive retaining members 486, and nuts 488 are then threadably engaged with retaining members 486, respectively, to secure pan 122 onto bracket 252. Nuts 488 may also be rotated to threadably disengage retaining member 486 such that, pan 122 can be removed from bracket 252.

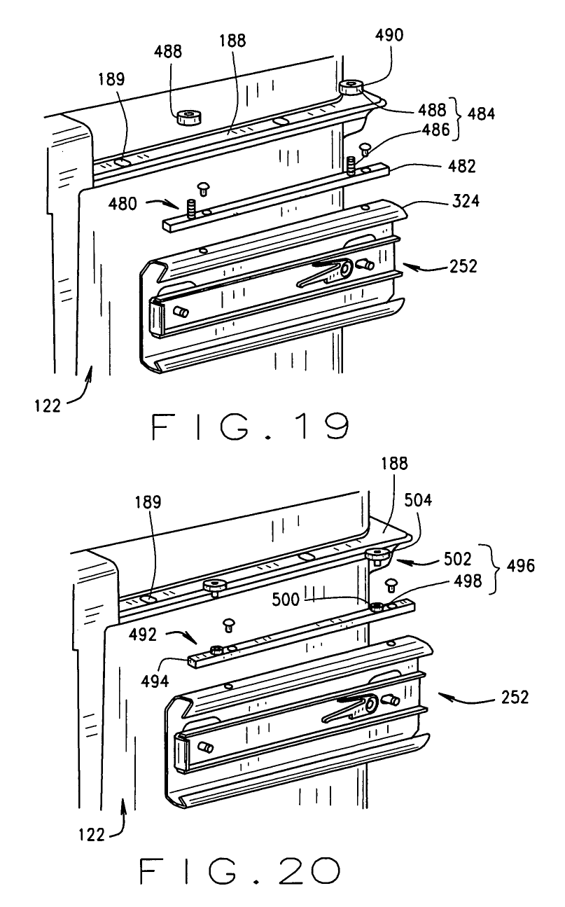

FIG. 20 illustrates an alternative retainer 492 applicable to bracket 252 shown in FIG. 19. Retainer 492 is similar to retainer 480 and engages bracket 252 and mounting portion 188 of pan 122 in a similar way. Retainer 492 also includes an elongated retainer bar 494 and two locking mechanisms 496. Each locking mechanism 496 includes a retaining member 498 having a threaded hole 500 therein, and a threaded screw 502 for engaging with retaining member 498. In one exemplary embodiment, threaded screw 502 further includes a serrated outer surface 504 which facilitates the operator rotating threaded screw 502. In use, retaining member 498 is inserted into opening 189 of mounting portion 188, and threaded screw 502 threadably engages or disengages retaining member 498 to facilitate pan 122 fastening onto, or disengaging from, bracket 252.

The embodiments thus described provide a bottom pan support assembly that can be easily removed and installed by an end user using his hands and requiring no tools for disassembly and assembly. The design is reliable and easy to maintain. The assembly uses few parts which, when combined with simple installation without tools, lowers production costs. Additionally, service technicians require no extra tools to service the assembly.

While the invention has been described in terms of various specific embodiments, those skilled in the art will recognize that the invention can be practiced with modification within the spirit and scope of the claims.

What is claimed is:

1. A drawer assembly for a refrigerator having compartment walls defining a cooling compartment, said drawer assembly comprising:
a pan having a mounting portion; and
a bracket coupled to one of the compartment walls, said bracket comprising a locking mechanism movable between a first position and a second position, said pan mounted to said bracket such that said locking mechanism engages said mounting portion of said pan, wherein said pan is secured to said bracket when said locking mechanism is in the first position, and said pan is configured to be removed from said bracket when said locking mechanism is in the second position.

2. A drawer assembly in accordance with claim 1 wherein said latch member is movable between the first and second positions without using tools.

3. A drawer assembly in accordance with claim 1 wherein said mounting portion of said pan comprises an opening, said pan mounted to said bracket by positioning said locking mechanism within said opening.

4. A drawer assembly in accordance with claim 1 wherein said bracket further comprises a slide assembly positioned between said bracket and the respective compartment wall such that said bracket is slidably coupled to the respective compartment wall.

5. A drawer assembly in accordance with claim 1 wherein said locking mechanism is rotatable between the first and second positions.

6. A drawer assembly in accordance with claim 1 wherein said mounting portion of said pan comprises two openings and said bracket comprises two locking mechanisms, said locking mechanisms received by respective said openings.

7. A drawer assembly in accordance with claim 1 wherein said locking mechanism comprises a swing lock.

8. A drawer assembly in accordance with claim 1 wherein said locking mechanism comprises a snap lock.

9. A drawer assembly in accordance with claim 1 wherein said locking mechanism comprises at least one of a threaded screw and a threaded nut.

10. A drawer assembly in accordance with claim 1 wherein said locking mechanism comprises a retaining member extending from said bracket and received by said mounting portion of said pan.

11. A drawer assembly in accordance with claim 10 wherein said locking mechanism further comprises a retainer clip configured to receive a portion of said retaining member, said retainer clip slidable between said first and second positions to secure said pan to said bracket.

12. A drawer assembly in accordance with claim 10 wherein said locking mechanism further comprises a retainer clip configured to receive a portion of said retaining member, said retainer clip rotatable between said first and second positions to secure said pan to said bracket.

13. A drawer assembly in accordance with claim 1 wherein said bracket further comprises a hook member extending therefrom, said hook member configured to engage and retain a portion of said mounting portion of said pan when said pan is mounted to said bracket.

14. A refrigerator comprising:
a cooling compartment defined by a plurality of compartment walls;
a pan assembly slidably mounted within said cooling compartment, said pan assembly comprising a pan having a mounting portion and a bracket coupled to one of the compartment walls, said bracket comprising a locking mechanism movable between a first position and a second position, said pan mounted to said bracket such that said locking mechanism engages said mounting portion of said pan, wherein said pan is secured to said bracket when said locking mechanism is in the first position, and said pan is configured to be removed from said bracket when said locking mechanism is in the second position.

15. A refrigerator in accordance with claim 14 wherein said mounting portion of said pan comprises an opening, said pan mounted to said bracket by positioning said locking mechanism within said opening.

16. A refrigerator in accordance with claim 14 wherein said bracket further comprises a slide assembly positioned between said bracket and a respective one of the compartment walls such that said bracket is slidably coupled to said compartment wall.

17. A refrigerator in accordance with claim 14 wherein said locking mechanism comprises a retaining member extending from said bracket and received by said mounting portion of said pan.

18. A refrigerator in accordance with claim 17 wherein said locking mechanism further comprises a retainer clip for receiving a portion of said retaining member, said retainer clip rotatable between the first and second positions to secure said pan to said bracket.

19. A method for assembling a drawer assembly for a refrigerator having a cooling compartment defined by a plurality of compartment walls, said method comprising:
coupling a bracket to one of the compartment walls of the refrigerator;
coupling a locking mechanism to the bracket, wherein the locking mechanism is movable between a first position and a second position; and
mounting a pan having a mounting portion to the bracket such that the locking mechanism engages the mounting portion, wherein the pan is secured to the bracket when the locking mechanism is in the first position, and the pan is configured to be removed from the bracket when the locking mechanism is in the second position.

20. A method in accordance with claim 19 wherein said coupling a locking mechanism to the bracket comprises coupling a locking mechanism to the bracket that is rotatably moveable between the first and second positions.
